(19) United States
(12) Patent Application Publication
(10) Pub. No.: US 2002/0165741 A1
(43) Pub. Date: Nov. 7, 2002

(54) Method and system for providing registration and loss protection services to consumer jewelry owners

(76) Inventors: Seth P. Becker, Bloomfield, CT (US); Paul J. Becker, West Hartford, CT (US); Jack Gredinger, Trumbull, CT (US)

Correspondence Address: CANTOR COLBURN LLP, 55 Griffin Road South, Bloomfield, CT, 06002, US

(21) Appl. No.: 10/020,728

(22) Filed: Oct. 29, 2001

Related U.S. Application Data
(60) Provisional application No. 60/288,975, filed on May 4, 2001.

(51) Int. Cl. G06F 17/60

(52) U.S. Cl. 705/4

(57) ABSTRACT

The present invention relates to a method for providing registration services and loss protection services related to marked jewelry for new jewelry consumer purchases or existing consumer owned items. Upon transferring ownership of a uniquely inscribed, marked, encoded, or otherwise identifiable gemstone or jewelry item, the facilitator of the registration and loss protection services (e.g., a dealer or retailer) includes (without limiting it to) both a database registration service and a loss protection service. This may occur before, or shortly after a transfer of ownership transaction takes place. Ultimately, this leads to the end consumer receiving at point of sale registration services and loss protection services included in their diamond, gemstone and/or jewelry purchase, which creates many added-value benefits and peace of mind such as providing replacements. Detailed information pertaining to the jewelry owner, the identification information and characteristics and value of the jewelry item, along with other relevant information may be registered into a database for tracking, identification, protection and recovery purposes. Data can be entered prior to sale to a consumer for greater tracking throughout a distribution chain. The method also comprises updating the database upon the occurrence of an event relating to the marked jewelry item, including: a transfer of ownership, loss, destruction, theft, damage, recovery, settlements, as are current and updated evaluations.

### CROSS-REFERENCE TO RELATED APPLICATIONS

This application claims the benefit of U.S. provisional patent application Ser. No. 60/288,975 filed May 4, 2001, the entire contents of which are incorporated herein by reference.

### BACKGROUND OF THE INVENTION

The present invention relates to a tracking and recovery method and system, and more particularly, to a jewelry item registration, repair, and replacement method and system. In the case of precious diamonds, gemstones, or other fine jewelry, it is important to be able to easily and accurately identify them for insurance protection reasons and for purposes of theft, loss prevention, and recovery services. This is particularly true for valuable items that have been insured. The most common problem with recovering a jewelry item is being able to accurately identify it. Finders of lost or stolen jewelry items need to be able to accurately identify the items before recovery by their owners can be realized. This problem has been of particular concern to insurance companies that insure jewelry owners and face potentially fraudulent claims where valuables cannot be traced or identified. Furthermore, police often rely on jewelers to identify jewelry which were lost or stolen in an effort to resolve cases. In fact, recent statistics reported by the FBI indicate that approximately only four percent of all stolen jewelry nationwide is ever recovered. Without a way to identify these items and trace them to their owners, corresponding investigation and recovery processes will continue to be hampered.

A system that assists with the identification, tracking and recovery of diamonds and gemstones is disclosed in U.S. Pat. No. 5,983,238, entitled, “Gemstone Identification, Tracking, and Recovery System” and is incorporated herein by reference in its entirety. The identification, tracking and recovery system includes a central database for electronically storing unique and relevant information pertaining to a plurality of diamond and gemstone items for the purpose of assisting with the identification and recovery of these lost or stolen items. The information of each item is stored as a diamond or gemstone item entry in the database which includes the characteristics of the item; a unique identifier or indicia that is inscribed into a surface of the item or otherwise inscribed or marked by other permanent marking processes; and personal information of the owner of the item. A user interface enables a user to communicate with a processor that stores and retrieves the relevant information from the database in accordance with an algorithm. The processor is capable of cross-referencing the information of the stored item entry to enable retrieval of the item entry based on any known information, such as a unique marking on the diamond/gemstone and/or certification number, as well as information pertaining to owner of the item. In addition, the user may flag the item entry of a lost or stolen diamond or gemstone to easily identify the status of the ownership of the item and also enable the system. The flagged item entries may then be retrieved to generate reports such as a listing of all of the lost or stolen items stored in the database.

Owners of valuable jewelry items are likely to acquire some type of insurance protection. Homeowners' policies provide only a limited amount of protection for personal valuables. Such limitations often times include sizeable deductibles and claim disbursements well below the value of the items insured. This is so because homeowners' policies are primarily structured to accommodate losses relating to the home or its fixtures. Also, homeowners' policies usually require that any items to be covered in the home be specifically identified within the policy before recoveries on claims for losses can be rendered. This involves having to update the policy, individually identifying each item, every time an item needs to be added or removed. This is, no doubt, a time-consuming and tedious chore for the homeowner who must be especially disciplined in this endeavor, or else the item to be covered will not be properly protected under the policy. Furthermore, mistakes are common on the policy resulting from the details communicated from the jewelry owner to the insurance company and the information actually appearing on the policy correctly.

Insurance specialists in the market today currently offer private jewelry insurance or warranty protection to jewelry owners via one of two business models. Under one such model, a retailer is generally covered by an insurance specialist under a policy for their generic insurance block needs which allows only the retailer to distribute the specialist's consumer insurance brochures to consumers at the point of purchase. Insurance specialists such as Jewelers Mutual Insurance Company™ and International Jewelers Block & Fine Arts Insurance Services, Inc. (IJB) offer individual insurance policies to those consumers of the retailer. If a retailer is not presently covered by the insurance specialist, this plan cannot be offered. This model can also be implemented by other entities such as dealers and e-tailers in the jewelry industry. The consumer is responsible for applying for this plan on his/her own, usually after leaving the retailer's store. This usually entails that the consumer complete forms at home and pay an additional amount of money for the protection on top of the cost of the jewelry item. A check, form and proof of item valuation (detailed sales receipt) must be mailed to the insurance specialist (or e-mailed with credit card information). A distinct disadvantage of this model is that the customer is afforded no interim protection between the time of purchase and approval of the application. Errors in filling out or mailing the forms, misplacing the forms and/or sales receipt, forgetfulness in pursuing the insurance once the customer gets home, are further disadvantages of this model.

The second business model involves purchasing a large insurance policy, such as by a wholesaler or dealer to cover a specific lot of jewelry. The wholesaler sells jewelry and includes an extended consumer warranty for a limited period of time. Claims for losses go directly to the wholesaler for processing. This model is utilized by ArtCarved™ which sells class rings to students. The warranty services students or purchasers of class rings through a plan known as Protection Against Loss or Stolen (P.A.L.S) Replacement Agreement which is purchased by ArtCarved™ and delivered to consumer ring purchasers upon sale. A processing fee is charged by the wholesaler, ArtCarved™ for the handling of all claims, and limited protection is provided. Further the claimant/consumer must provide the original receipt of purchase, the warranty agreement, and the actual ring if damage is claimed, all of which can be quite inconvenient. This type of warranty may be suitable for low value items, such as class rings, but would not offer comparable benefits to items of considerable value. Further, the ArtCarved™ program entails no such registry or inscribed/marking, and is limited to a single replacement under its warranty.

It is therefore desirable to provide a method for bundling registration and loss protection services for an identifiable diamond/gemstone or jewelry item which is effectuated early in the distribution cycle and which facilitates the identification, tracking, transferability, insurance and recovery of the item. On the spot consumer benefits would provide immediate registration and insurance protection at the point of sale.

### SUMMARY OF THE INVENTION

The above-mentioned drawbacks and deficiencies of the prior art are overcome or alleviated by the bundling of registration and loss protection services of the present invention which does not interfere with normal jewelry trade business practices. Upon transferring ownership of a uniquely marked or identifiable diamond, gemstone, or jewelry item, the facilitator of the registration and loss protection services (e.g., a wholesaler, sightholder, dealer or retailer) bundles both a database registration service and a loss protection service at or before or just after a transfer of ownership transaction takes place. Detailed information pertaining to the jewelry owner, identification information and specific characteristics of the jewelry item, the value of the jewelry item, the scope and provisions of the loss protection plan may all be entered into a database for tracing purposes. Some of this data can be entered by the sightholder, wholesaler, dealer or retailer prior to sale to a consumer for greater tracking capabilities throughout a distribution chain. The method also comprises updating the database upon the occurrence of an event relating to the marked jewelry item, including: a transfer of ownership, loss, destruction, theft, damage, recovery, any settlements initiated and current evaluation data. Any necessary repairs or replacements of the protected item can be provided by the sightholder/wholesaler/dealer through the retailer, or by the retailer of the jewelry. The consumer can report any losses upon knowledge of loss or damage, or the retailer or sightholder/wholesaler/dealer may provide the contact services.

### BRIEF DESCRIPTION OF THE DRAWINGS

Referring now to the drawings wherein like elements are numbered alike in the several figures:

FIG. 1 is an exemplary block diagram of a portion of a system upon which the bundled registration and loss protection plan is implemented;

FIG. 2 is a flowchart describing the process of providing bundled registration and loss protection services for a selected and identifiable jewelry item or quantity of jewelry items through a wholesale and retail distribution chain; and

FIG. 3 is a flowchart describing the process of providing registration and loss protection services for consumer-owned or post-purchase items.

### DETAILED DESCRIPTION OF THE PREFERRED EMBODIMENT

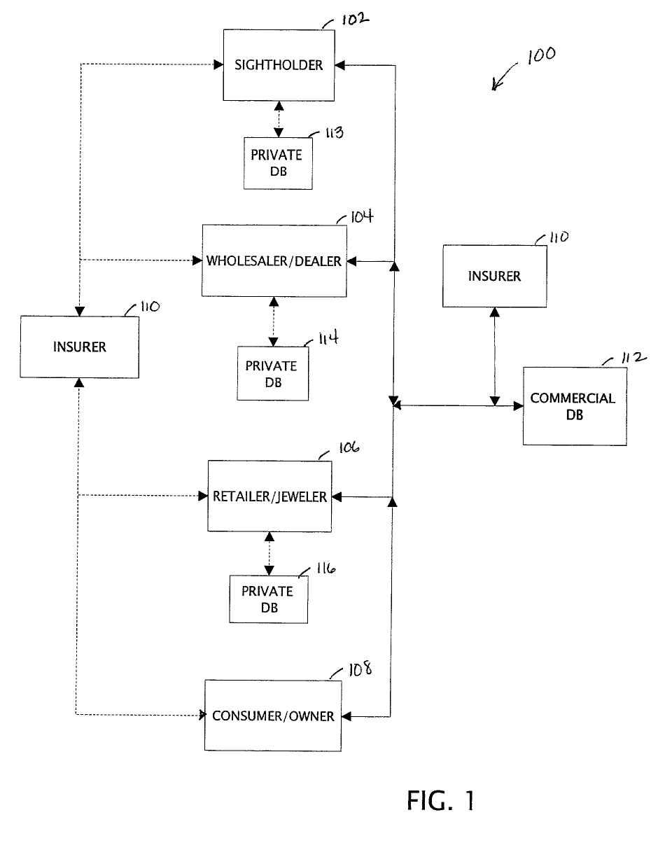

Bundled registration and loss protection services may be implemented throughout a distribution chain via system 100 of the present invention as described in FIG. 1. Registration and loss protection services include repairing, replacing, and reappraising inscribed or marked jewelry items such as gemstones and diamonds (hereinafter “gemstones”). Although the invention is described herein with respect to inscribed or marked gemstones, it is understood that the invention may be used for diamonds and a variety of inscribed or marked jewelry items (e.g., rings, watches, necklaces, bracelets, gemstones, etc.). Entities which may be involved in the distribution chain include a commercial database 112, sightholder 102, a wholesaler or dealer 104 (hereinafter “dealer”), a retailer or jeweler 106, (hereinafter “retailer”), and a consumer or owner 108 (hereinafter “consumer”). Also included in system 100 is an insurance provider 110 (hereinafter “insurer”) which is under a contractual arrangement with one of entities 112, 102, 104, or 106 to pass along loss protection services to a consumer 108 which allows the insurance to be at a cost lower than the selling price at retail, making it less expensive and more convenient to obtain protection. A sightholder refers to some person or organization that acts as a supplier or distributor providing gemstones for dealer 104, retailer 106, or consumer 108, or may be the entity buying direct from a diamond-producing source. Sightholder 102 and/or dealer 104 can sell gemstones to retailer 106 or to consumer 108. Retailer 106 is typically a jewelry store, chain, or e-tailer that sells gemstones to consumer 108 and provides related consumer services such as repairs, appraisals, and the like. State insurance licensing laws may prevent the sightholder, dealer, or retailer from acting as an insurance agent. Insurer 110 may be an insurance company specializing in providing pass along consumer insurance loss protection services for items such as gemstones via a policy covering specified inscribed or marked lots of gemstones owned by entities 102-106 for purposes of resale to consumer 108.

A purchaser 102-108 of a gemstone or lot of gemstones subject to insurer's 110 coverage plan may register the gemstone(s) in a database such as database 112 which provides a centrally located, repository of information related to gemstones and their owners. Database 112 can be a commercially operated and maintained database which provides bundled gemstone registration services and insurance protection options to entities 102-106. Registration database 112 may be, for example, Diamond ID™ described above in U.S. Pat. No. 5,983,238 or may be a database/applications service provider or ASP. The system may be configured to allow authorized users to access the commercial database on a subscription basis. Also, database 112 may be housed within insurer 110. Alternatively, sightholder 102, dealer 104 and/or retailer 106 may employ their own databases 113, 114, and 116, respectively, and provide packaged/bundled insurance protection and registration services to customers such as consumer 108. Furthermore, retailer 106 may be a customer of dealer 104 or sightholder 102 for purposes the bundled registration and insurance services provided. Entities 102-106 may process and enter the appropriate personal information for consumer 108. Alternatively, consumer 108 with access permission may choose to register their information for an approved gemstone directly with any of databases 112-116 if desired (depending on the type of program being offered to consumer 108). Transfer of information may be by any suitable means of communication.

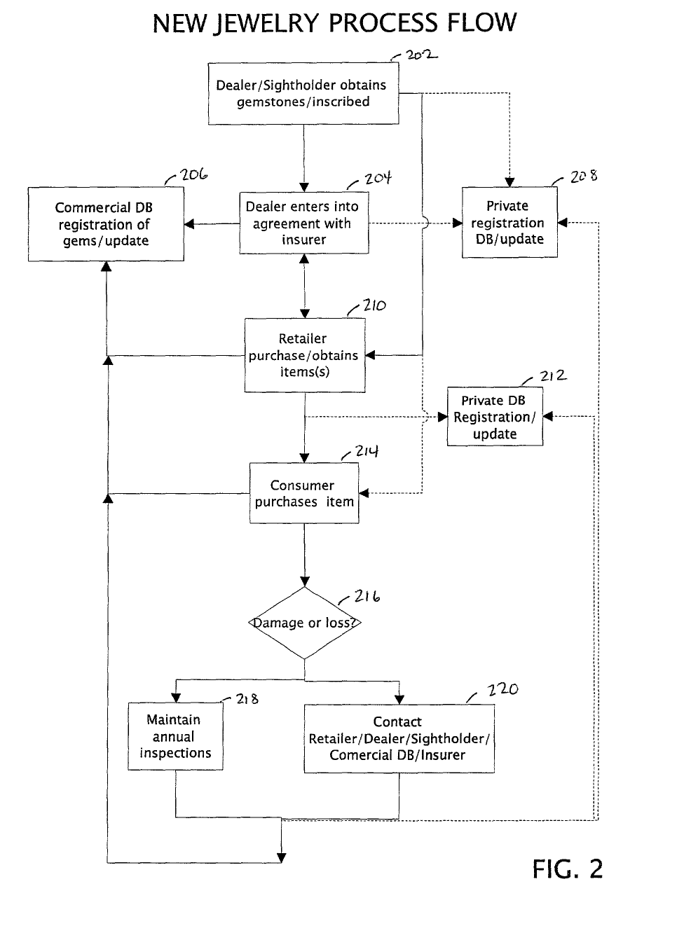

FIG. 2 is a flowchart describing the process of implementing the bundled registration and loss protection plan for one or more gemstones at the sightholder, wholesale and retail level. A sightholder, dealer or retailer obtains the lot at step 202 for the purposes of resale to a wholesaler 104, retail organization 106, or consumer 108. A ‘lot’ refers to any quantity of jewelry items or gemstones and can refer to a single item or many items. The dealer or retailer may have purchased the items from a sightholder 102 or dealer 104 which have been inscribed and includes the bundled program with a unique identifier or may have the items inscribed and enroll in the program themselves. The sightholder 102 or dealer 104, may enter into an agreement with insurer 110 and/or commercial database 112, which enables insurer 110 to provide immediate loss protection services to consumer 108 at or after the point of purchase at step 214. Data pertaining to the lot items is entered into a database for identifying, recovery, insurance, and tracking purposes. An “activation” form/card (hard copy) may then be included with each lot item. A dealer may select a commercial service or database 112 for providing the database services at step 206, or may utilize its own in-house database registration system 113 or 114 at step 208, 212.

A retailer 106 obtains one or more items at step 210 which are either already registered by sightholder 102 or dealer 104, or retailer 106 can alternatively enter into an agreement with insurer 110 and also register the items itself at step 212 and add its own activation form/card. The retailer 106, sightholder 102, or dealer 104 can update database 112 or provide information to database 112 which itself updates the information accordingly at step 206. Otherwise, retailer 106, sightholder 102, or dealer 104 may update one of its corresponding private databases 113, 114 or 116 at step 208 or 212 if a privately-operated database. Updating these databases includes, but is not limited to, providing transfer of ownership information and passing along registration and insurance.

A consumer 108 purchases one or more items from retailer 106, sightholder 102, or dealer 104 at step 214 and ownership information is again updated via database 112 at step 206 or one of databases 113, 114, or 116. This may be done by use of an activation form/card that is returned to insurer 110 by entities 102, 104, 106 or 108, or entered into the system at the time of transaction. Consumer 108 maintains current evaluation information of the registered gemstone by having it inspected regularly, preferably on an annual basis at step 218. If a loss should occur (step 216), consumer 108 notifies one of the retailer 106, dealer 104, sightholder 102, insurer 110, or database 112 at step 220. Upon notification, updates are again made to the appropriate database(s), either database 112 at step 206 or one of databases 113, 114, or 116 at steps 208 or 212 respectively. Entries made may include “lost”, “stolen”, “destroyed”, flags. Once notification occurs, one of entities 102, 104, 106, 110 or 112 evaluates the extent of the loss and provides subsequent repairs, or in the event of total loss, either replaces the item with another of like quality and value, or makes a cash settlement under the terms of the insurance policy. Insurer 110 reimburses entities 102, 104, 106, or 108 for its costs and labor and the appropriate database is updated again.

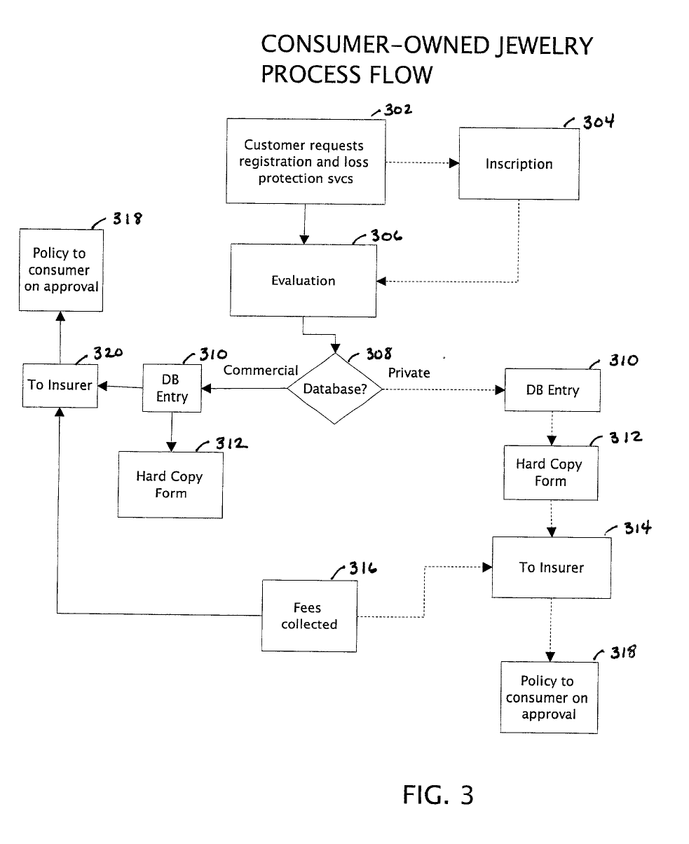

Alternatively, rather than initiate bundling the registration and loss protection services at the sightholder, dealer or retailer level, the bundling may occur solely at the retail level in a similar manner as that described in FIG. 2 whereby a consumer deals directly with the retailer. FIG. 3 further illustrates this process. One model would require retailer 106 to be an insurance specialist under this embodiment who is licensed to sell or deal in insurance matters, or the insurance and registration can take effect with the retailer having a contractual relationship with commercial database 112 and or insurer 110 who provides bundled registration/insurance protection services via an agreement with insurer 110. A consumer 108 requests registration and loss protection services for previously-purchased gemstones or jewelry items at step 302. Retailer 106 inscribes the item(s) by sending to an entity that inscribes or having their own device for such purposes that inscribes at their location at step 304. In the alternative, the jewelry item comes into the retailer shop already inscribed. Retailer 106 evaluates the item at step 306 and then enters registration information, or consumer 108 can enter all pertinent jewelry and consumer information into database 112 or a private database such as 116 at step 308. If Retailer 106 utilizes a private label database, this information is completed therein at step 310 by the retailer or the consumer entering it in at retail location. Alternatively, the consumer may enter in appropriate information from home. Retailer 106 may instruct consumer 108 to fill out a hard copy (activation) registration/insurance form (step 312) that needs to be forwarded to insurer 110 in accordance with current insurance laws in effect at step 314. Consumer 108 may opt to solely utilize the registration services of his/her marked item and not the insurance component. If a hard copy activation form is sent to database or entity 112, database 112 could forward the information to insurer 110 at step 320. The required registration fees are forwarded to insurer 110 or database 112. Once insurer 110 receives the appropriate information, it issues a policy to consumer 108 at step 318.

In either case, consumer 108 is immediately covered by either registration or bundled insurance protection upon leaving retailer's 106 store or when the activation mechanism is completed and placed in a U.S. post office box. Insurer 110 sends an endorsement policy directly to consumer 108 upon approval of submitted hard copy form and covering funds (step 318). Loss procedures employed are similar to those discussed providing for jewelry items replacement by retailer 106 or a cash settlement to consumer 108 by insurer 110, if the item(s) cannot be replaced.

The insurer 110 has been described as a separate entity. The insurance component may be offered by other entities such as database provider 112. In addition, any entity may provide the bundling of the registration and/or insurance component. For example, a gemological lab that evaluates gemstones may establish the registration and insurance components that follow the jewelry item through distribution. Alternatively, a service provider may provide marking on the jewelry item, registration and/or insurance (and other services such as appraisals) at one or more locations such as a retail store or “service center.”

As described, transfer of ownership information from dealers to retailers to consumers is tracked in various ways in order to effectuate processing throughout the distribution cycle. Registration data pertaining to an inscribed jewelry item and its owner, together with insurance data facilitates the identification, tracking, insurance coverage, repair, and replacement processes, simply as a result of a new purchase by the consumer because it is automatically included with purchase. This in turn, provides the jewelry owner with a value-added benefit not provided by prior art methods. Benefits of added security and current valuation data for insured jewelry items which are readily accessible to insurers in the program is another advantage of the invention. Providing consumers automatic registration and insurance protection included with their purchases at the point of sale creates many peace of mind benefits.

While preferred embodiments have been shown and described, various modifications and substitutions may be made thereto without departing from the spirit and scope of the invention. Accordingly, it is to be understood that the present invention has been described by way of illustration and not limitation.

1. A system for providing registration services and loss protection services related to marked jewelry, comprising:
a database for registering said marked jewelry; and
a loss protection system in communication with said database for bundling said registration services with said loss protection services related to said marked jewelry.

2. The system of claim 1 wherein said database includes ownership data related to said marked jewelry.

3. The system of claim 1 wherein said database includes distinguishing characteristics of said marked jewelry for tracking and identification purposes.

4. The system of claim 1 wherein said database includes fees collected and owed.

5. The system of claim 1 wherein said database includes value of said marked jewelry.

6. The system of claim 1 wherein said loss protection systems provides said database with policy data relating to coverage terms selected.

7. The system of claim 1 wherein said loss protection systems provides said database with updated inspection data relating to said marked jewelry.

8. The system of claim 1 wherein said loss protection systems provides said database with transfer of ownership data.

9. The system of claim 1 wherein said loss protection systems provides said database with occurrence of events relating to said marked jewelry including one of theft, loss, destruction and recovery.

10. The system of claim 1 wherein said loss protection services are bundled with said registration services after transfer of ownership of a jewelry item to a consumer, the consumer paying an additional cost for loss protection services bundled with said registration services.

11. The system of claim 1 wherein said loss protection services are bundled with said registration services before transfer of ownership of a jewelry item to a consumer, a cost of said loss protection services bundled with said registration services being included in a cost of the marked jewelry item to the consumer.

12. The system of claim 11 wherein a wholesaler includes the registration services and loss protection services in the cost of the jewelry item, the wholesaler transferring the jewelry item to at least one entity prior to the consumer obtaining the jewelry item.

13. The system of claim 1 wherein the database and the loss protection system are implemented by the same system.

14. The system of claim 1 wherein the database includes an identification of marking on the marked jewelry item.

15. A method for providing registration services and loss protection services related to marked jewelry, comprising:
initiating said registration services by registering a marked jewelry item in a database;
initiating said loss protection services;
bundling the registration services with the loss protection services;
providing the bundled registration services and loss protection services to a consumer; and,
updating said database upon an occurrence of an event relating to said marked jewelry item.

16. The method of claim 15 wherein the updating said database occurs upon one of a transfer of ownership, loss, destruction, theft, damage, recovery and settlements initiated.

17. The method of claim 15 wherein terms of loss protection services include identification information for said marked jewelry item.

18. The method of claim 15 wherein terms of loss protection services include a value of said marked jewelry item.

19. The method of claim 15 wherein terms of loss protection services include ownership information related to said marked jewelry item.

20. The method of claim 15 wherein said marked jewelry item includes a jewelry item that has been marked with an identification marking.

21. The method of claim 15 wherein said database is a commercial database accessible by authorized entities.

22. The method of claim 15 wherein said initiating said loss protection service agreement includes collecting activation information and transferring said activation information to a provider of said loss protection services.

23. The method of claim 15 wherein said loss protection services are bundled with said registration services after transfer of ownership of a jewelry item to a consumer, the consumer paying an additional cost for loss protection services bundled with said registration services.

24. The method of claim 15 wherein said loss protection services are bundled with said registration services before transfer of ownership of a jewelry item to a consumer, a cost of said loss protection services bundled with said registration services being included in a cost of the marked jewelry item to the consumer.

25. A method for providing registration services related to marked jewelry, comprising:
a wholesaler initiating said registration services by registering a marked jewelry item in a database;
the wholesaler including the cost of the registration services in a cost of the marked jewelry item;
the marked jewelry item begin transferred from the wholesaler to at least one additional entity; and,
the database being updated to indicate transfers of the marked jewelry item.
